(19) United States
(12) Patent Application Publication
(10) Pub. No.: US 2014/0265466 A1
(43) Pub. Date: Sep. 18, 2014

(54) SHELL FOR SADDLES OR SEATS OF VEHICLES

(71) Applicant: VELO ENTERPRISE CO., LTD., Taichung City (TW)

(72) Inventor: TSAI-YUN YU, TAICHUNG CITY (TW)

(73) Assignee: VELO ENTERPRISE CO., LTD., Taichung City (TW)

(21) Appl. No.: 14/030,162

(22) Filed: Sep. 18, 2013

(30) Foreign Application Priority Data
Mar. 15, 2013 (TW) 102204849

(51) Int. Cl. B62J 1/00

(52) U.S. Cl. CPC B62J 1/00
USPC 297/195.1

(57) ABSTRACT

A shell or support with a holding portion is provided for combining a saddle or seat of vehicles. The shell comprises a top surface, a bottom surface, a front end and a rear end. The contour of the shell includes a narrow front portion and a wide rear portion which are arranged in order from the front end to the rear end. The holding portion is disposed on the bottom surface and near the rear end. Thus, when the shell is assembled with other parts to form a saddle or seat, the vehicle with such a saddle can be easily removed when being unridden.

### BACKGROUND OF THE INVENTION

1. Field of the Invention

The present invention relates generally to a saddle or seat of a vehicle, and more particularly to a shell or support with a holding portion for such saddles or seats.

2. Description of the Related Art

It is well known that the conventional vehicle saddles or seats, such as bicycle or motorized bicycle saddles, are often positioned at the middle portion of the bicycles not only for supporting biker's body but for holding to remove the bicycles when being unridden. However, these prior art saddles are disadvantageous in that they have no suitable places or areas for bikers to easily hold thereon when them want to remove the bicycles with such saddles during unriding time.

It is an object of the present invention to provide a shell or support for a saddle or seat of a vehicle, with which the saddle can be held in a simple manner to remove the vehicle when it is in a motionless state.

### SUMMARY OF THE INVENTION

According to the present invention, a shell or support including a holding portion is provided for combining with other parts to construct a saddle or seat of vehicles. The shell comprises a top surface, a bottom surface, a front end and a rear end. The contour of the shell includes a narrow front portion and a wide rear portion which are arranged in order from the front end to the rear end. The holding portion is disposed on the bottom surface and near the rear end. Thus, when the shell is assembled with other parts to form a saddle or seat, the vehicle with such a saddle can be easily removed when it is in a motionless state.

In a preferred embodiment, the holding portion is a concave area extending upwardly from the bottom surface of the shell.

In another preferred embodiment, the holding portion includes an opened concave area having a front side, a rear side, a right side, a left said and a bottom side so that a suitable space is defined for being held.

In a particularly preferred embodiment, the shell further comprises a rear side wall defined by the rear side of the holding portion and the rear end of the shell such that a biker's hand can lean against thereon when holding on the holding portion.

In another particularly preferred embodiment, the holding portion further includes a rim extending downwardly from the edge of the opening of the concave area. Furthermore, the rim may have a right side portion, a left side portion and a front side portion. The shell further comprises a first rear socket located adjacent to the right side portion of the rim, and a second rear socket located adjacent to the left side portion of the rim. The first and second rear sockets are provided for being inserted by the ends of a suspension rail of the saddle.

### BRIEF DESCRIPTION OF THE DRAWINGS

The following is a detailed description of preferred embodiments of the present invention with reference to the associated drawings, wherein:

FIG. 1 is a schematic perspective bottom view of a first embodiment of the shell for a bicycle saddle according to the present invention;

FIG. 2 is a partial sectional view of the shell taken along line 2-2 of FIG. 1;

FIG. 3 is a schematic perspective bottom view of a second embodiment of the shell for a bicycle saddle according to the present invention;

FIG. 4 is a partial sectional view of the shell taken along line 4-4 of FIG. 3, and

FIG. 5 is a schematic perspective bottom view of a third embodiment of the shell for a bicycle saddle according to the present invention.

### DETAILED DESCRIPTION OF PREFERRED EMBODIMENTS

In a first embodiment of the present invention, as shown in FIGS. 1-2, a shell 10 for a bicycle saddle comprises a top surface 12, a bottom surface 14, a front end 16 and a rear end 18. The shell 10 is made of rigid plastic materials and contoured to have a narrow front portion 20 and a wide rear portion 22. Furthermore, the shell 10 includes a holding portion 24 disposed on the bottom surface 14 and near the rear end 18. In this embodiment, the holding portion 24 is an opened concave area extending upwardly from the bottom surface 14 to the top surface 12. The concave area 24 includes a front side 242, a rear side 244, a right side 246, a left side 248 and a bottom side 250 to define a suitable space for being held. The rear side 244 of the concave area 24 and the rear end 18 of the shell 10 defines a rear side wall 26 such that a biker's hand can insert into the space defined by the concave area 24 and lean against on the rear side wall as the holding portion is used. For being comfortable to being leant against, the rear wall 26 is designed to have an under curved edge 262 (as shown in FIG. 2).

With reference to FIGS. 3-4, a shell for a bicycle saddle constructed according to a second embodiment of the present invention is designated as numeral 30. The shell 30 is generally similar to the shell 10 except the differences mentioned below. The first is that the shell 30 has an opened concave area 32 and a rim 34 extending downwardly from the edge of the opening of the concave area 32. The rim 34 includes a front side portion 342, a right side portion 344 and a left side portion 346 such that the concave area 32 can have a depth being deeper than that of the concave 24 of the shell 10 for easily being held. The second is that the shell 30 further includes a front socket 36 disposed on the bottom surface 38 and near the front end 40, a first rear socket 42 located adjacent to the right side portion 344 of the rim 34, and a second rear socket 44 located adjacent to the left side portion 346 of the rim 34 so that a suspension rail 50 of a bicycle saddle can be mounted on the shell 30. Speaking detailedly, the suspension rail 50 has a front end 52 being inserted into the front socket 36, a first rear end 54 being inserted into the first rear socket 42, and a second rear end 56 being inserted into the second rear socket 44 (as best seen in FIG. 3).

Lastly, please referring to FIG. 5, the shell 60 is constructed according to a third embodiment of the present invention. The difference between the shell 60 and the shell 30 is that the first rear socket 62 is connected directly to the right side portion 642 of the rim 64, and the second rear socket 66 is connected directly to the left side portion 644 of the rim 64 so that the first and second rear socket 62, 66 can be bridged directly by the front side portion 646 of the rim 64 for balancedly transmitting the pressure coming from the saddle 60 to the suspension rail 70.

What is claimed is:

1. A shell for a saddle or seat for a vehicle, comprising:
a top surface, a bottom surface, a front end and a rear end;
a narrow front portion and a wide rear portion arranged in order from said front end to said rear end; and
a holding portion disposed on said bottom surface and near said rear end.

2. The shell of claim 1, wherein said holding portion is a concave area extending upwardly from said bottom surface.

3. The shell of claim 1, wherein said holding portion includes an opened concave area having a front side, a rear side, a right side, a left side and a bottom side.

4. The shell of claim 3, further comprising a rear side wall defined by said rear side of said holding portion and said rear end of said shell for being leaned against as said holding portion is used.

5. The shell of claim 3, wherein said holding portion further includes a rim extending downwardly from the edge of the opening of the concave area.

6. The shell of claim 5, wherein said rim includes a right side portion, a left side portion and a front side portion.

7. The shell of claim 6, further comprising a first rear socket located adjacent to said right side portion of said rim, and a second rear socket located adjacent to said left side portion of said rim.

8. The shell of claim 6, further comprising a first rear socket connected directly to said right side portion of said rim, and a second rear socket connected directly to said left side portion of said rim.

9. The shell of claim 4, wherein said rear side wall has an under curved edge.

10. The shell of claim 7, further comprising a front socket disposed on said bottom surface of said shell and adjacent to said front end of said shell.
